(19) United States
(12) Patent Application Publication
(10) Pub. No.: US 2011/0219082 A1
(43) Pub. Date: Sep. 8, 2011

(54) APPARATUS AND METHOD OF COMMUNICATING WITH LOCAL SERVICE

(75) Inventor: Jun Hyeong KIM, Anyang-si (KR)

(73) Assignee: SAMSUNG ELECTRONICS CO., LTD., Suwon-si (KR)

(21) Appl. No.: 12/858,149

(22) Filed: Aug. 17, 2010

(30) Foreign Application Priority Data
Mar. 2, 2010 (KR) 10-2010-0018535

(51) Int. Cl. G06F 15/16

(52) U.S. Cl. 709/206; 709/219

(57) ABSTRACT

A local service accessing method, and apparatuses to perform operations of the method, the method including transmitting current location information to a local service directory, receiving local service information associated the current location information from the local service directory, and accessing the local service server using the local service information.

### CROSS-REFERENCE TO RELATED APPLICATION(S)

This application claims the benefit under 35 U.S.C. §119(a) of Korean Patent Application No. 10-2010-0018535, filed on Mar. 2, 2010, in the Korean Intellectual Property Office, the entire disclosure of which is incorporated herein by reference for all purposes.

### BACKGROUND

1. Field

The following description relates to a local service accessing apparatus and method, and more particularly, to a method and a system in which a mobile terminal detects and uses a local service around the mobile terminal in an environment including a broadband wireless network and a local wireless network.

2. Description of Related Art

Development of mobile communication technologies and wireless positioning technologies enable a user location-based mobile Internet service to be provided. The user location-based mobile Internet service is referred to as a Location-based Service (LBS). Examples of the LBS may include a Navigation service, a Point of Interest service, a Tracking service, a Location-based Advertisement service, and the like, and contents may be changed based on the location of the user.

Generally, the local service may be accessible only via a local wireless network, and may be inaccessible via a broadband communication network, such as the Internet and the like.

### SUMMARY

An aspect of various embodiments provides a local service accessing apparatus and method that easily detects and uses, independent of a mobile communication operator, various surrounding local services even in an environment including a broadband wireless network and a local wireless network.

Another aspect of various embodiments provides a local service accessing apparatus and method that automatically performs a setting operation and a connecting operation used to utilize a local service by only selecting a local service by a user.

The foregoing and/or other aspects may be achieved by providing a method of accessing a local service, the method including transmitting current location information to a local service directory, receiving local service information associated with the current location information from the local service directory, and accessing a local service server using the local service information.

The method may further include requesting a local service execution code from the local service server, receiving the local service execution code from the local service server, and executing the received local service execution code.

The requesting may include transmitting input/output information associated with a terminal.

The input/output information may include information associated with a size of a display of the terminal, information associated with a definition, information associated with a color, information associated with a touch screen, information associated with a speaker, information associated with a microphone, or any combination thereof.

The receiving may include receiving the local service execution code including information associated with an execution environment of the local service server.

The execution environment may be .NET, Java Runtime Environment, Python Environment, Wireless Internet Platform for Interoperability (WIPI) Environment, Interference Similarity Graph Index (ISGI) Environment, or any combination thereof.

The local service server may be an adjacent terminal of the terminal.

The current location information may include a latitude, a longitude, a time, or any combination thereof.

The local service information may include a local service list and/or a communication network list.

The foregoing and/or other aspects may also be achieved by providing a terminal including a location collecting unit to collect current location information, and a local service server detecting unit to transmit a local service information request message including the current location information to a local service directory, and to receive a local service information response message from the local service directory to access a local service server.

The terminal may also include an execution code downloading unit to request a local service execution code from the local service server, and to receive the local service execution code from the local service server, and an execution code execution unit to execute the received local service execution code.

The execution code downloading unit may transmit input/output information of the terminal when requesting the local service execution code.

The input/output information may include information associated with a size of a display of the terminal, information associated with a resolution, information associated with a color, information associated with a touch screen, information associated with a speaker, information associated with a microphone, or any combination thereof.

The execution code downloading unit may receive information associated with an execution environment of the local service server together with the local service execution code.

The execution environment may be .NET, Java Runtime Environment, Python Environment, WIPI Environment, ISGI, or any combination thereof.

The foregoing and/or other aspects may also be achieved by providing a local service directory including a local service information inventory to maintain at least one item of local service information, a message receiving unit to receive, from a terminal, a local service information request message including current location information of the terminal, an information parsing unit to parse local service information corresponding to the current location information with reference to the local service information inventory, and a message transmitting unit to transmit a local service information response message including the local service information.

The local service information may include a local service list and/or a communication network list.

The foregoing and/or other aspects may also be achieved by providing a local service server including an execution code storage unit to record at least one local service execution code, a message receiving unit to receive a local service execution code request message from a terminal, an information parsing unit to parse, with reference to the execution code storage unit, a local service execution code corresponding to the local service execution code request message received from the terminal, and an execution code transmitting unit to transmit the local service execution code.

The execution code transmitting unit may further transmit information associated with an execution environment of the local service server.

The execution environment may be .NET, Java Runtime Environment, Python Environment, WIPI Environment, ISGI, or any combination thereof.

The local service server may be an adjacent terminal of the terminal.

Other features and aspects may be apparent from the following detailed description, the drawings, and the claims.

### BRIEF DESCRIPTION OF THE DRAWINGS

FIG. 1 is a network configuration diagram illustrating a mobile Internet environment including a broadband wireless network and a local wireless network.

FIG. 2 is a diagram illustrating an example of a system of detecting and using a local service around a user mobile terminal.

FIG. 3 is a flowchart illustrating a process in which a mobile terminal communicates with a local service system to detect and to use the local service around the mobile terminal.

FIG. 4 is a block diagram illustrating an example of an internal configuration of a mobile terminal that detects and uses a local service around a local wireless network.

FIG. 5 is a diagram illustrating an example of a network configuration in which a mobile terminal detects and uses a wireless LAN-based local service.

FIG. 6 is a block diagram illustrating an example of a local service directory.

FIG. 7 is a block diagram illustrating an example of a local service server.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein may be suggested to those of ordinary skill in the art. Any progression of operations described is merely exemplary, as the sequence and/or operations are not limited to those set forth herein and may be changed as is known in the art. Also, descriptions of well-known functions and constructions may be omitted for increased clarity and conciseness.

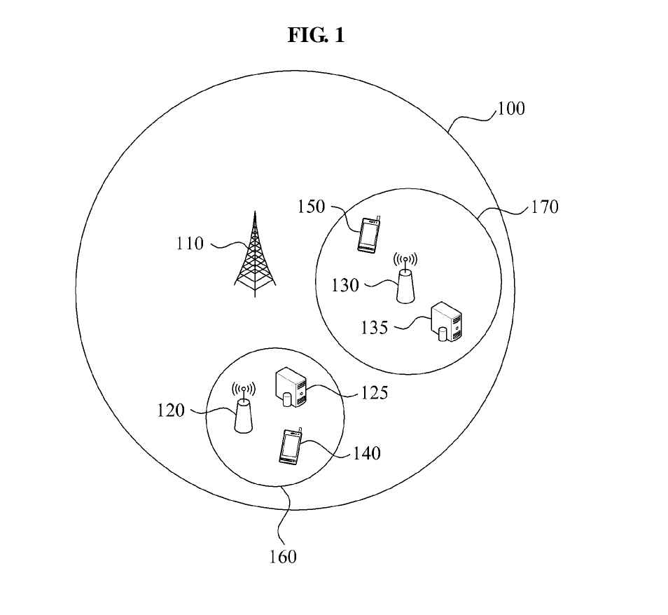

FIG. 1 is a network configuration diagram illustrating a mobile Internet environment including a broadband wireless network and a local wireless network.

Mobile terminals 140 and 150 may perform voice, video, and/or data communication based on a broadband wireless network 100 without a limitation of time and place. To perform such a communication, mobile terminals 140 and 150 may access a base station 110 of the broadband wireless network 100. The mobile terminals 140 and 150 may use a local service or may perform the voice, video, and/or data communication via local wireless networks 160 and 170, such as a picocell, a femtocell, a wireless LAN hotspot, a Bluetooth hotspot, and the like. The mobile terminals 140 and 150, local wireless network equipment 120 and 130, and local wireless network management servers 125 and 135 may be located in the respective local wireless networks 160 and 170. The local service may be accessible only via the local wireless networks 160 and 170, and may be inaccessible via the Internet. Examples of the local service may include a guidance service, a coupon service, a ticket service, and the like.

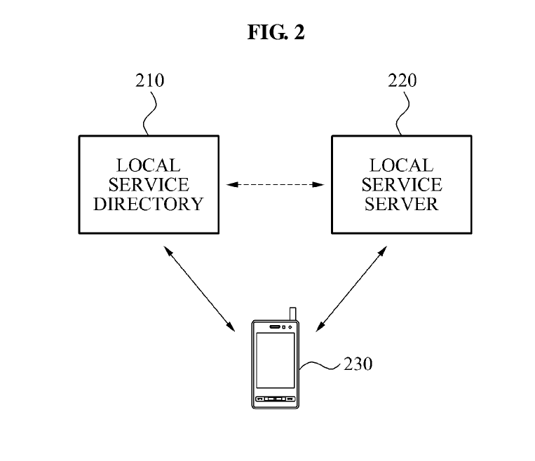

FIG. 2 illustrates an example of a system of detecting and using a local service around a user mobile terminal. Throughout this disclosure, the term “around” in regard to a local service around a user mobile terminal will generally simply indicate that the user mobile terminal is in the service area of the local service system. Referring to FIG. 2, a local service system may include a local service directory 210 and a local service server 220, and may communicate with a mobile terminal 230 to provide a local service with respect to a corresponding location.

The local service may be a service that is accessible and usable only via a local wireless network, examples of which may include a guidance service, a coupon service, a ticket service, and the like. When the mobile terminal 230 uses the local service, the mobile terminal 230 may include a protocol stack used to exchange a message and data with the local service system, and may include a capability of understanding and processing the exchanged message and data.

The local service server 220 may provide a local service execution code to the mobile terminal 230. The local service execution code may be a program that the mobile terminal 230 may load to execute. The local service execution code may include a local service connecting unit, a message and data transceiver, a message and data processing unit, and so on, and may use, depending on the local service execution code, the local service even when the mobile terminal 230 is unaware of a local service accessing method or does not include the protocol stack used to exchange the message and data, a message and data processing unit, and the like.

The local service directory 210 may generally be located in the Internet, and may provide information that the mobile terminal 230 uses to detect and use a local service around the mobile terminal 230. For example, the local service directory 210 may include a local service information inventory including at least one item of local service information, and may provide, to the mobile terminal 230, local service information corresponding to current location information of the mobile terminal 230 in response to a request of the mobile terminal 230.

When the mobile terminal 230 uses the local service around the mobile terminal 230, the mobile terminal 230 may be connected to a local wireless network interoperating with a desired local service and may be connected to a local service server 220 in the local wireless network. The mobile terminal 230 may have difficulty recognizing a type of a local service existing around the mobile terminal 230, may have difficulty recognizing which local service is connected to which local wireless network, and may have difficulty determining a method of connecting to the local service server 220 after connecting to the local wireless network. Therefore, there may be difficulty in using the local service. The local service directory 210 may receive, from the mobile terminal 230, a request message requesting information regarding a local service around the mobile terminal 230, and may transmit a response message to enable the mobile terminal 230 to easily detect and use the local service around the mobile terminal 230. In this case, the request message may include location information of the mobile terminal 230.

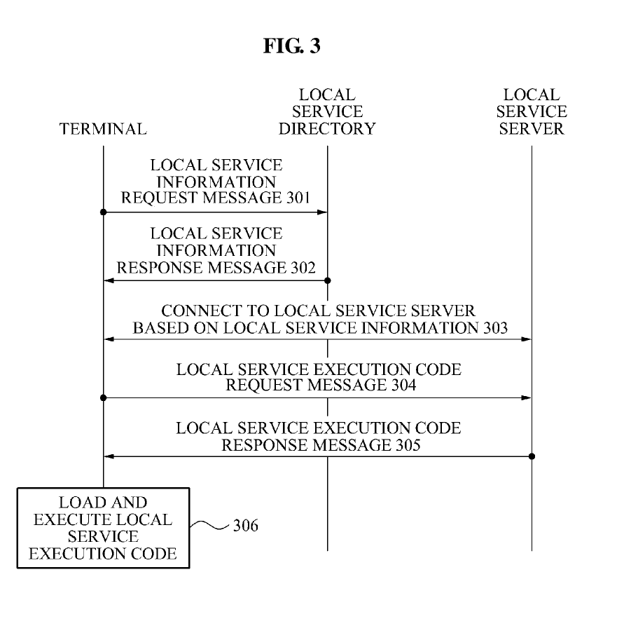

FIG. 3 illustrates a process in which a mobile terminal communicates with a local service system to detect and use the local service around the mobile terminal.

The mobile terminal may transmit a local service information request message including location information of the mobile terminal to a local service directory in operation 301. In this example, the mobile terminal may be connected to the Internet via a broadband wireless network, and the like.

The local service directory that receives the local service information request message from the mobile terminal may transmit a local service information response message to the mobile terminal in operation 302. The local service information response message may include local service information regarding the local service around the mobile terminal, and the local service information may include a description about the local service, a method of accessing a local wireless network interoperating with the local service, a method of accessing a local service server within the local wireless network, and the like.

The mobile terminal may access the local wireless network based on the local service information included in the local service information response message, and may be connected to the local service server which may provide a local service execution code in operation 303.

The mobile terminal accessing the local service server may transmit a local service execution code request message to the local service server in operation 304.

The local service server may transmit a local service execution code response message to the mobile terminal in operation 305, and the mobile terminal that receives the local service execution code response message may load and execute the local service execution code included in the corresponding message in operation 306.

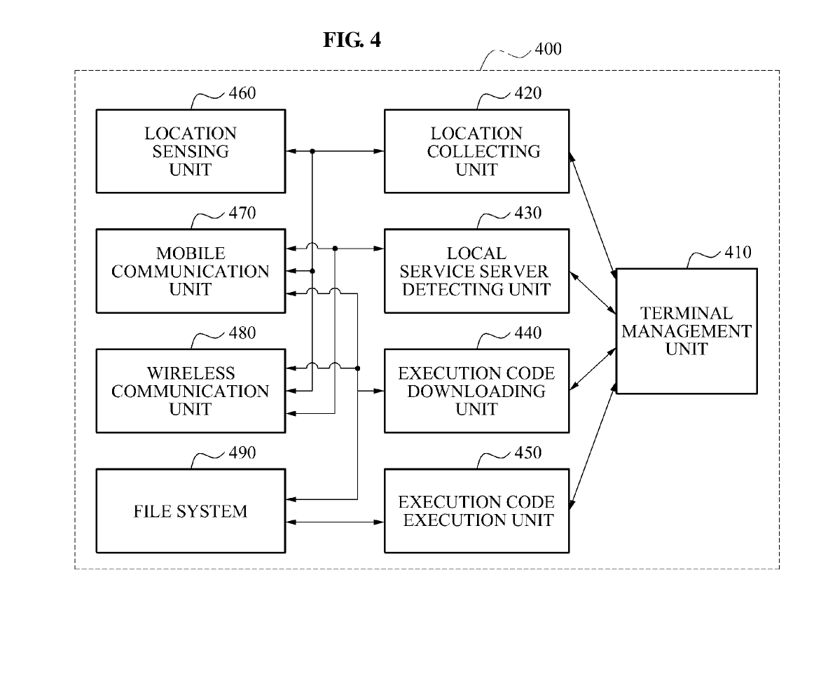

FIG. 4 illustrates an example of an internal configuration of a mobile terminal 400 that may detect and use a local service around a local wireless network.

Referring to FIG. 4, the mobile terminal 400 may include various function modules. A location collecting unit 420 may collect current location information of the mobile terminal 400 based on various wireless positioning technologies. To collect the current location information, the mobile terminal 400 may include a location sensing unit 460, a mobile communication unit 470, and a wireless communication unit 480. The location sensing unit 460 may include one or more sub-modules, such as a GPS module, and the like, as a sensor module used to recognize a current location of the mobile terminal 400.

A local service server detecting unit 430 may provide, to a local service directory, the current location information of the mobile terminal 400 collected from the location collecting unit 420, and may request local service information regarding the service area around the mobile terminal 400. The local service server detecting unit 430 may receive the local service information from the local service directory, in response to the request.

An execution code downloading unit 440 may be connected to a local wireless network and a local service server based on the received local service information, and may request a local service execution code from the local service server. The execution code downloading unit 440 may receive the local service execution code and may store the received local service execution code in a file system 490.

An execution code execution unit 450 may load and execute the local service execution code, and may manage a life cycle of the local service execution code. The local service execution code may include a local service connecting unit, a message and data transceiver, a message and data processing unit, and the like, and, thus, the mobile terminal 400 may use the local service even when the mobile terminal 400 is unaware of a local service accessing method or does not include a local service accessing method, and does not include a message and data transceiver, a message and data processing unit, and the like used to communicate with the local service server.

A terminal management unit 410 may manage and execute the described function modules, as well as other possible included function modules, and thus enables the mobile terminal 400 to easily detect and use the local service around the mobile terminal 400.

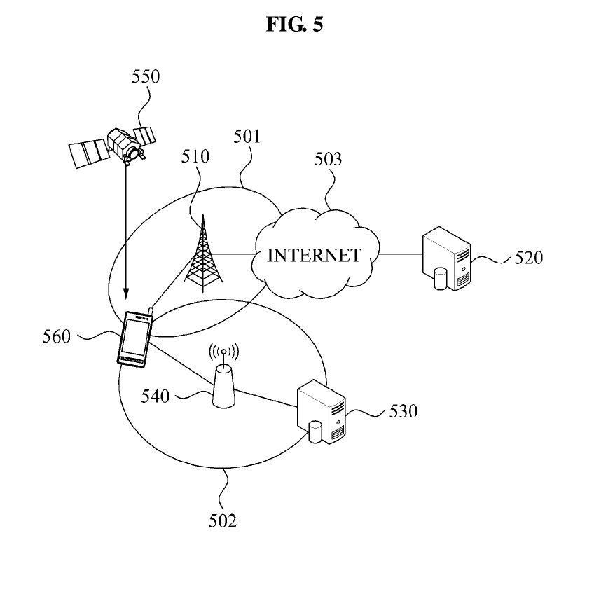

FIG. 5 illustrates an example of a network configuration in which a mobile terminal 560 may detect and use a wireless LAN-based local service. Referring to FIG. 5, a process of using the wireless LAN-based local service is described.

The mobile terminal 560 may collect current location information using a location sensing unit, such as a global positioning system (GPS) module that receives a GPS signal from an embedded GPS satellite 550. However, the mobile terminal 560 is not limited to this GPS method of sensing a current location. When the GPS is used, the current location information of the mobile terminal 560 may be expressed based on a latitude, a longitude, and an altitude in a World Geodetic System 1984 (WGS 84) coordinate system. The latitude and the longitude may be expressed based on a DMS scheme using degrees, minutes, and seconds. The latitude may have a value between −90 degrees and 90 degrees, and the longitude may have a value between −180 degrees and 180 degrees. The altitude may be a height from WGS-84 Ellipsoid and may be expressed based on a metric unit such as a meter.

The mobile terminal 560 may access a base station 510 of a wireless Internet service network 501 to access the Internet 503. The mobile terminal 560 accessing the Internet 503 may transmit a local service information request message to a local service directory 520. The wireless Internet service network 501 may be classified, based on a transmission scheme, into a wireless LAN, such as 802.11b/a/g/n, and the like, a mobile communication system, such as Universal Mobile Telecommunications System (UMTS), code division multiple access (CDMA)-2000, long term evolution (LTE), and the like, and a mobile Internet service system, such as WiBro, WiMAX, and the like. A type of the wireless Internet service systems 501 available may be changed based on a function of the mobile terminal 560, a type of a service available in a current location, whether a user subscribes for a service, and the like.

An address of the local service directory 520 may be stored, in advance, in the mobile terminal 560, or may be allocated from a dynamic host configuration protocol (DHCP) server while an IP address is set. The local service information request message may be expressed based on a text or a binary code. In a case in which a message expressed by the binary code is used, the message may be of an appropriately small size to be used in a mobile environment. However, a user may have difficulty understanding the corresponding message and the message may have insufficient scalability. In a case in which a message expressed by text, a size of the message may be larger than the message expressed by the binary code, and the user may easily understand the message and the message may be scalable. According to another embodiment, a message may be encoded based on eXtended Markup Language (XML) and the encoded message may be transmitted using a hypertext transfer protocol (HTTP) protocol and the like. In a case in which the XML is used, a document may be easily structured and may be easily exchanged between systems. An example of a local service information request message based on the XML may be as follows.

<GeoServiceInfoRequest>
<Coordinate>
<WGS84Coordinate>
<Latitude>32.121944</Latitude>
<Longitude>116.86520</Longitude>
<Altitude>10.0</Altitude>
</WGS84Coordinate>
</Coordinate>
</GeoServiceInfoRequest>

The mobile terminal 560 may receive a local service information response message from the local service directory 520. The local service directory 520 that receives the local service information request message from the mobile terminal 560 may locate a local service information inventory based on the current location information of the mobile terminal 560 included in the local service information request message.

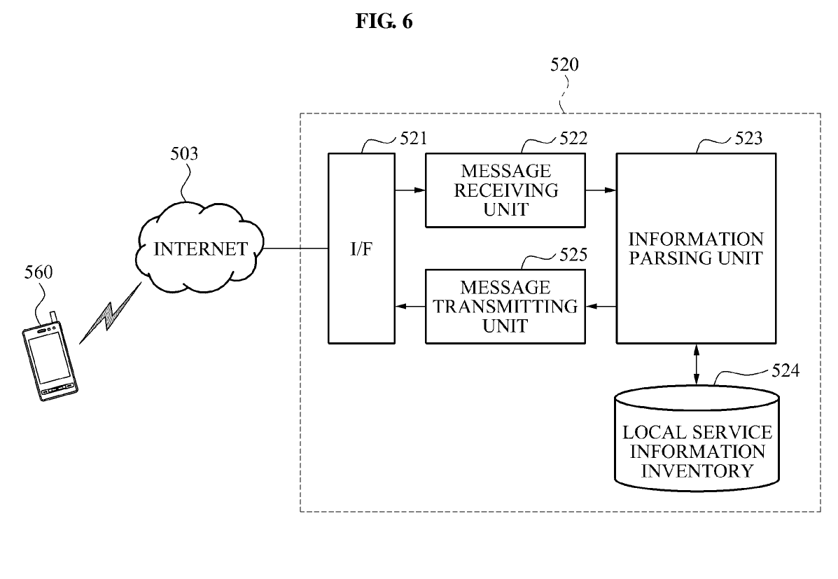

A configuration of the local service directory 520 is described with reference to FIG. 6.

FIG. 6 illustrates an example of the local service directory 520. Referring to FIG. 6, the local service directory 520 may include a message receiving unit 522, an information parsing unit 523, a local service information inventory 524, and a message transmitting unit 525. The local service directory 520 may further include a communication interface unit 521. In more detail, the local service directory 520 may include the local service information inventory 524 to maintain at least one item of local service information, the message receiving unit 522 to receive, from the mobile terminal 560, a local service information request message including current location information of the terminal, the information parsing unit 523 to parse local service information corresponding to the current location information with reference to the local service information inventory 524, and the message transmitting unit 525 to transmit a local service information response message including the local service information to the terminal.

The current location information of the mobile terminal may include a latitude, a longitude, and an altitude, and the local service directory 520 may search for a local service around the mobile terminal 560 based on latitude information and longitude information. According to an embodiment, altitude information may be used as a reference.

A location managed by the local service directory 520 may be divided into cells that are not overlapping each other, and the local service directory 520 may provide information associated with local services in which the mobile terminal 560 is accessible, among local services of a cell including the terminal and adjacent cells. Whether the mobile terminal 560 is accessible to a local service may be determined based on whether the mobile terminal 560 is included in a local wireless network 502 as a service providing area of the local service. The local service information may include a description of the local service, a method of accessing a local wireless network 502 interoperating with the local service, a method of accessing a local service server 530 within the local wireless network 502, and the like. The method of accessing the local wireless network 502 interoperating with the local service may include a wireless communication technology, a wireless communication setting parameter, a wireless communication address collecting method, and the like. The method of accessing the local service server 530 within the local wireless network 502 may include an address of the local service server 530, a transmission protocol, a setting parameter, and the like. An example of a local service information response message based on XML may be as follows.

<GeoServiceInfoResponse>
<Coordinate>
<WGS84Coordinate>
<Latitude>32.121944</Latitude>
<Longitude>116.86520</Longitude>
<Altitude>10.0</Altitude>
</WGS84Coordinate>
</Coordinate>
<GeoServiceInfo>
<ServiceDescription>
Everland
</ServiceDescription>
<NetworkConnection>
<WiFi type=“802.11n”>
<Mode>infrastructure</Mode>
<SSID>ever_ap1</SSID>
<IPConfig>dhcp</IPConfig>
</WiFi>
</NetworkConnection>
<ServiceServerConnection>
<HTTP>
http://10.1.0.10:8888/evertourguide.jar
</HTTP>
</ServiceServerConnection>
</GeoServiceInfo>
<GeoServiceInfo>
<ServiceDescription>
Hyundai Oilbank
</ServiceDescription>
...
</GeoServiceInfo>
...
</GeoServiceInfoResponse>

A user of the mobile terminal 560 may select a local service based on the received description of the local service information. It is presumed, for the purposes of this example, that the user selects EVERLAND from among received local services including EVERLAND, HYUNDAI OIL BANK, and the like.

The mobile terminal 560 may access the local wireless network 502 based on a method of accessing a local wireless network of selected EVERLAND local service information. The mobile terminal 560 may turn on a power of an 802.11n wireless LAN module, and may search around the mobile terminal 560 in an infrastructure mode to detect accessible 802.11n wireless LAN access points (APs). The mobile terminal 560 may access an AP of which a service set identifier (SSID) is ever_ap1 from among the detected APs. When the mobile terminal 560 accesses the AP of which the SSID is ever_ap1, the mobile terminal 560 may use a basic value, and may use a Dynamic Host Configuration Protocol (DHCP) protocol to receive an allocated Internet protocol (IP) address and allocated variables associated with an IP. The mobile terminal 560 may use the allocated IP address and the allocated variables associated with the IP to set an IP address of a wireless LAN network interface.

The mobile terminal 560 may access an EVERLAND local service server based on a method of accessing the EVERLAND local service server of the selected EVERLAND local service information, and may download an EVERLAND local service execution code from the EVERLAND local service sever. For example, an IP address of the EVERLAND local service server may be 10.1.0.10, and the mobile terminal 560 may download the EVERLAND local service execution code, namely, evertourguide.jar, from a transmission control protocol (TCP) port 8888, using the HTTP protocol.

Although this example has described an operation in which the mobile terminal 560 downloads the local service execution code using the HTTP protocol without exchanging a message with the local service server 530, the mobile terminal 560 may negotiate with the local service server 530 for an appropriate local service execution code to download the local service execution code according to another embodiment. For example, the mobile terminal 560 may use a protocol predetermined by a local service server accessing method, and may negotiate with the local service server for an execution environment of the local service execution code, an input and output specification of the mobile terminal 560, and the like. The input and output specification of the mobile terminal 560 may include a display input and output specification, such as a size, a resolution, a color, a touch screen, and the like, and a voice input and output specifications, such as a speaker, a microphone, and the like. The execution environment of the local service execution code may include .NET, Java Runtime Environment, Python Environment, Brew, Wireless Internet Platform for Interoperability (WIPI) Environment, Interference Similarity Graph Index (ISGI), and the like.

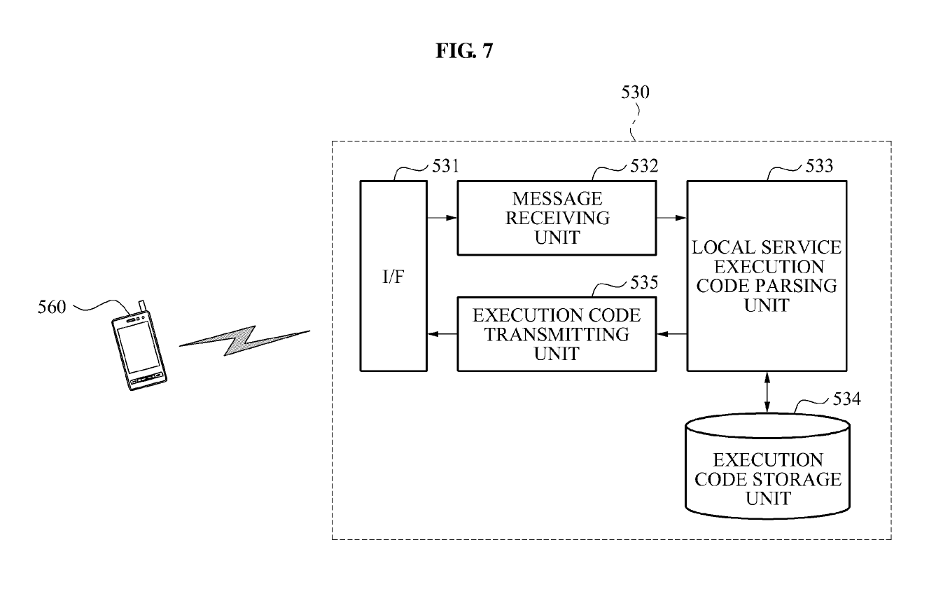

A configuration of a local service server 530 illustrated in FIG. 5 is described with reference to FIG. 7.

FIG. 7 illustrates an example of the local service server 530. Referring to FIG. 7, the local service server 530 may include a message receiving unit 532, a local service execution code parsing unit 533, an execution code storage unit 534, and an execution code transmitting unit 535. The local service server 530 may further include a communication interface unit 531. In more detail, the local service server 530 may include the execution code storage unit 534 to record at least one local service execution code, the message receiving unit 532 to receive a local service execution code request message from the mobile terminal 560, the local service execution code parsing unit 533 to parse a local service execution code corresponding to the local service execution code request message with reference to the execution code storage unit 534, and the execution code transmitting unit 535 to transmit the local service execution code to the mobile terminal 560, such as through local wireless network equipment 540.

The mobile terminal 560 may load and execute the local service execution code downloaded from the local service server 530 to use a local service. An evertourguide.jar file that the terminal 560 may download may be a container file of the local service execution code, and may include the local service execution code and a manifest file describing a method of executing the local service execution code. The mobile terminal 560 may interpret the manifest file to learn the method of executing the local service execution code and may load and execute the local service execution code.

The local service execution code may be a program that the mobile terminal 560 loads and executes, and may include a local service connecting unit, a message and data transceiver, a message and data processing unit, and the like. Also, the local service execution code may enable the mobile terminal 560 to use the local service even when the mobile terminal 560 is unaware of a local service accessing method, or does not include a protocol stack used to exchange message and data, a message and data processing unit, and the like. Generally, hardware and operation systems of the mobile terminals are different from one another. Accordingly, when a local service execution code is written in a form of a native code associated with the operation system, the local service execution code may be separately written for each individual operation system. In such a situation, much time and manpower may be used and maintenance may be difficult. Accordingly, an execution environment simulation independent from an operation system of the mobile terminal 560 may be installed, and a local service execution code may be written in a form suitable to be used in the execution environment simulation, and thus, the local service execution code may be executed independent from the operation system of the mobile terminal 560. Generally, the local service execution code may be used to embody and expand a predetermined interface, and the mobile terminal 560 may be embodied to call an interface of the local service execution code to load and execute the local service execution code. The interface of the local service execution code may be identified through a negotiation between the local service server 530 and the mobile terminal 560 or may be identified by interpreting the manifest file included in the local service execution code.

A number of exemplary embodiments have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of accessing a local service, the method comprising:
transmitting current location information to a local service directory;
receiving local service information associated with the current location information from the local service directory; and
accessing the local service server using the local service information.

2. The method of claim 1, further comprising:
requesting a local service execution code from the local service server;
receiving the local service execution code from the local service server; and
executing the received local service execution code.

3. The method of claim 2, wherein the requesting comprises:
transmitting input/output information associated with a terminal.

4. The method of claim 3, wherein the input/output information includes information associated with a size of a display of the terminal, information associated with a definition, information associated with a color, information associated with a touch screen, information associated with a speaker, information associated with a microphone, or any combination thereof.

5. The method of claim 2, wherein the receiving comprises receiving the local service execution code including information associated with an execution environment of the local service server.

6. The method of claim 5, wherein the execution environment is .NET, Java Runtime Environment, Python Environment, Wireless Internet Platform for Interoperability (WIPI) Environment, Interference Similarity Graph Index (ISGI) Environment, or any combination thereof.

7. The method of claim 1, wherein the local service server is an adjacent terminal of the terminal.

8. The method of claim 2, wherein the local service server is an adjacent terminal of the terminal.

9. The method of claim 1, wherein the current location information includes a latitude, a longitude, a time, or any combination thereof.

10. The method of claim 1, wherein the local service information includes a local service list and/or a communication network list.

11. A terminal comprising:
a location collecting unit to collect current location information; and
a local service server detecting unit to transmit a local service information request message including the current location information to a local service directory, and to receive a local service information response message from the local service directory to access a local service server.

12. The terminal of claim 11, further comprising:
an execution code downloading unit to request a local service execution code from the local service server, and to receive the local service execution code from the local service server; and
an execution code execution unit to execute the received local service execution code.

13. The terminal of claim 12, wherein the execution code downloading unit transmits input/output information of the terminal when requesting the local service execution code.

14. The terminal of claim 13, wherein the input/output information includes information associated with a size of a display of the terminal, information associated with a resolution, information associated with a color, information associated with a touch screen, information associated with a speaker, information associated with a microphone, or any combination thereof.

15. The terminal of claim 11, wherein the execution code downloading unit receives information associated with an execution environment of the local service server together with the local service execution code.

16. The terminal of claim 15, wherein the execution environment is .NET, Java Runtime Environment, Python Environment, WIPI Environment, ISGI, or any combination thereof.

17. A local service directory comprising:
a local service information inventory to maintain at least one item of local service information;
a message receiving unit to receive, from a terminal, a local service information request message including current location information of the terminal;
an information parsing unit to parse local service information corresponding to the current location information with reference to the local service information inventory; and
a message transmitting unit to transmit a local service information response message including the local service information.

18. The local service directory of claim 17, wherein the local service information includes a local service list and/or a communication network list.

19. A local service server, comprising:
an execution code storage unit to record at least one local service execution code;
a message receiving unit to receive a local service execution code request message from a terminal;
an information parsing unit to parse, with reference to the execution code storage unit, a local service execution code corresponding to the local service execution code request message received from the terminal; and
an execution code transmitting unit to transmit the local service execution code.

20. The local service server of claim 19, wherein the execution code transmitting unit further transmits information associated with an execution environment of the local service server.

21. The local service server of claim 20, wherein the execution environment is .NET, Java Runtime Environment, Python Environment, WIPI Environment, ISGI, or any combination thereof.

22. The local service server of claim 19, wherein the local service server is an adjacent terminal of the terminal.

23. The local service server of claim 20, wherein the local service server is an adjacent terminal of the terminal.
